(19) United States
(12) Patent Application Publication
(10) Pub. No.: US 2020/0027060 A1
(43) Pub. Date: Jan. 23, 2020

(54) Logistics Path Planning Method and Device

(71) Applicant: Huawei Technologies Co., Ltd., Shenzhen (CN)

(72) Inventors: Huimin Zhang, Shenzhen (CN); Kangmin Huang, Shenzhen (CN)

(21) Appl. No.: 16/587,852

(22) Filed: Sep. 30, 2019

Related U.S. Application Data
(63) Continuation of application No. PCT/CN2017/117157, filed on Dec. 19, 2017.

(30) Foreign Application Priority Data
Mar. 30, 2017 (CN) 201710200991.1

(51) Int. Cl. G06Q 10/08

(52) U.S. Cl. CPC G06Q 10/08355; G06N 5/04

(57) ABSTRACT

A logistics path planning method and a device include receiving, by a logistics server, order information from a terminal, where the order information includes a shipper address, a consignee address, and configuration address information, where the configuration address information includes a transit address and/or a non-transit address specified by a user of the terminal, and planning, by the logistics server, a first logistics path based on the shipper address, the configuration address information, and the consignee address, where the first logistics path includes the transit address, the first logistics path does not include the non-transit address, or the first logistics path includes the transit address and does not include the non-transit address.

### CROSS-REFERENCE TO RELATED APPLICATIONS

This application is a continuation application of International Patent Application No. PCT/CN2017/117157 filed on Dec. 19, 2017, which claims priority to Chinese Patent Application No. 201710200991.1 filed on Mar. 30, 2017. The disclosures of the aforementioned applications are hereby incorporated by reference in their entireties.

### TECHNICAL FIELD

This application relates to the field of logistics technologies, and in particular, to a logistics path planning method and a device.

### BACKGROUND

With rapid development of e-commerce, logistics companies deliver increasingly more express packages. The logistics companies usually set up a plurality of distribution centers in an entire logistics area. Before an express package is delivered, express packages near a distribution center may be first aggregated, and then the express packages are delivered in a unified manner by areas. For example, for an express package sent from Xiamen to Shenzhen, after receiving the express package, a logistics company first sends the express package to a Fuzhou distribution center in a province in which Xiamen is located, and then sends the express package from Fuzhou to a Shenzhen distribution center.

However, it is found from practice that an express package that can be delivered in a straight line may be delivered through a longer path in such a delivery manner in which “aggregation is performed before delivery”. Particularly, when an express package is delivered from a shipper address to a consignee address, where an actual physical distance between the shipper address and the consignee address is relatively short, the express package may be first delivered to a nearby distribution center through a longer path before being delivered from the distribution center to the consignee address, and a delivery distance of the express package may be greater than an actual distance between the two places.

### SUMMARY

Embodiments of this application provide a logistics path planning method and a device, to shorten a delivery distance of an express package.

According to a first aspect, an embodiment of this application discloses a logistics path planning method, and the method includes receiving, by a logistics server, order information sent by a terminal, where the order information includes a shipper address, a consignee address, and configuration address information, and the configuration address information includes a transit address and/or a non-transit address specified by a user of the terminal, and planning, by the logistics server, a first logistics path based on the shipper address, the configuration address information, and the consignee address, where the first logistics path includes the transit address, or the first logistics path does not include the non-transit address, or the first logistics path includes the transit address and does not include the non-transit address.

According to the solution provided in this application, the logistics server can plan a logistics path based on the user-specified transit address and/or non-transit address. Compared with a case in which the logistics server directly plans a logistics path based on a shipper address and a consignee address, in the solution provided in this application, the user may participate in logistics path planning, and the transit or non-transit address during delivery of the express package is specified based on user's familiarity with a path around the shipper address or a path around the consignee address such that the express package can be delivered as straight as possible, delivery of the express package that is performed through a longer path in the background is avoided, and a delivery distance of the express package is shortened.

In a possible design, the logistics server calculates a first additional express fee and pushes the first additional express fee to the terminal, and/or the logistics server calculates a first additional time and pushes the first additional time to the terminal, where the first additional time is a difference between delivery duration used for delivery performed through the first logistics path and delivery duration used for delivery performed through the predetermined logistics path.

The logistics server may first obtain a path (namely, the predetermined logistics path) that is preset in a path planning map library and that is from the shipper address to the consignee address, and then use, as the first additional express fee, a difference between an express fee used for delivering the express package through the first logistics path and an express fee used for delivering the express package through the predetermined logistics path.

In a possible design, the logistics server calculates a first express fee used for delivery performed through the first logistics path, and pushes the first express fee to the terminal, and/or the logistics server calculates a first estimated arrival time for delivery performed through the first logistics path, and pushes the first estimated arrival time to the terminal.

According to the solution provided in this embodiment of this application, the logistics server obtains, through calculation, the first additional express fee, the first additional time, the first express fee, and the first estimated arrival time of the express package, and pushes the first additional express fee, the first additional time, the first express fee, and the first estimated arrival time to the terminal such that the user learns of an express fee and delivery duration used for delivering the express package through the first logistics path. In this way, the user decides, based on user's requirements for an express fee and delivery duration, whether to choose the first logistics path for delivery, and the solution is more user-friendly.

In a possible design, the logistics server may further mark the first logistics path, accumulate a quantity of times that the first logistics path is marked, and update a path planning map library with the first logistics path when the quantity of marking times is greater than a preset threshold of a quantity of times, where the path planning map library includes a plurality of paths.

Generally, a path that is marked for a relatively large quantity of times may be considered as a hot path with a relative high price/performance ratio. In this embodiment of this application, a path marked for a relatively large quantity of times is used to replace a logistics path that has the same shipper address and the same consignee address as the first logistics path and that is in the path planning map library. In addition to optimizing the path planning map library, a hot path with a relative high price/performance ratio may be provided for the user, thereby improving user experience.

In a possible design, the logistics server plans a second logistics path based on the shipper address and the consignee address and pushes the second logistics path to the terminal, where the second logistics path is another path than the first logistics path in paths from the shipper address to the consignee address.

In a possible design, the logistics server calculates a second additional express fee of the express package, and pushes the second additional express fee to the terminal, and/or the logistics server calculates a second estimated arrival time for delivering the express package to the consignee address through the second logistics path, and pushes the second estimated arrival time to the terminal.

The logistics server may first obtain a path (namely, the predetermined logistics path) that is preset in the path planning map library and that is from the shipper address to the consignee address, and then use, as the second additional express fee, a difference between an express fee used for delivering the express package through the second logistics path and the express fee used for delivering the express package through the predetermined logistics path.

This embodiment of this application may provide the user with more optional logistics paths such that the user can choose, based on user's requirements for an express fee and delivery duration, a more appropriate path to deliver the express package.

In a possible design, the transit address is an address that is in the first logistics path and that is adjacent to the shipper address.

In a possible design, when the logistics server delivers the express package through the first logistics path, the logistics server monitors a logistics status of the express package, and pushes, to the terminal, the logistics status of the express package that is obtained through monitoring.

According to the solution provided in this embodiment of this application, the logistics server may monitor the logistics status of the express package during delivery at any moment such that when a logistics fault of the express package occurs during the delivery, the logistics fault can be processed in time. In addition, the terminal may further display the logistics status of the express package to the user such that the user visually tracks and learns of a delivery status of the express package, thereby improving user experience.

According to a second aspect, an embodiment of this application discloses another logistics path planning method, and the method includes obtaining, by a terminal, order information, and sending the order information to a logistics server, where the order information includes a shipper address, a consignee address, and configuration address information, and the configuration address information includes a transit address and/or a non-transit address specified by a user of the terminal.

According to the solution provided in this application, the terminal may obtain the user-specified transit address and/or non-transit address such that the logistics server can plan a logistics path based on the user-specified transit address and/or non-transit address. Compared with a case in which the logistics server directly plans a logistics path based on a shipper address and a consignee address, in the solution provided in this application, the user may participate in logistics path planning, and the transit or non-transit address during delivery of the express package is specified based on user's familiarity with a path around the shipper address or a path around the consignee address such that the express package can be delivered as straight as possible, delivery of the express package that is performed through a longer path in the background is avoided, and a delivery distance of the express package is shortened.

In a possible design, the terminal receives a first additional express fee pushed by the logistics server, where the first additional express fee is a difference between an express fee used for delivery performed through a first logistics path and an express fee used for delivery performed through a predetermined logistics path, and/or the terminal receives a first additional time pushed by the logistics server, where the first additional time is a difference between delivery duration used for delivery performed through the first logistics path and delivery duration used for delivery performed through the predetermined logistics path.

The logistics server may first obtain a path (namely, the predetermined logistics path) that is preset in a path planning map library and through which the express package is delivered from the shipper address to the consignee address, and then use, as the first additional express fee, the difference between the express fee used for delivering the express package through the first logistics path and the express fee used for delivering the express package through the predetermined logistics path.

In a possible design, the terminal receives a first express fee pushed by the logistics server, where the first express fee is an express fee calculated by the logistics server for delivery performed through the first logistics path, and/or the terminal receives a first estimated arrival time pushed by the logistics server, where the first estimated arrival time is an arrival time calculated by the logistics server for delivery performed through the first logistics path.

According to the solution provided in this embodiment of this application, the terminal receives the first additional express fee, the first additional time, the first express fee, and the first estimated arrival time such that the user learns of an express fee and delivery duration used for delivering the express package through the first logistics path. In this way, the user decides, based on user's requirements for an express fee and delivery duration, whether to choose the first logistics path for delivery, and the solution is more user-friendly.

In a possible design, the terminal further receives a second logistics path pushed by the logistics server, where the second logistics path is another path than the first logistics path in paths that are from the shipper address to the consignee address and that are planned by the logistics server.

In a possible design, the terminal further receives a second additional express fee pushed by the logistics server, the second additional express fee is a difference between an express fee used for delivering the express package through the second logistics path and the express fee used for delivering the express package through the predetermined logistics path, and/or the terminal receives a second estimated arrival time pushed by the logistics server, and the second estimated arrival time includes an arrival time that is calculated by the logistics server and that is for delivering the express package to the consignee address through the second logistics path.

This embodiment of this application may provide the user with more optional logistics paths such that the user can choose, based on user's requirements for an express fee and delivery duration, a more appropriate path to deliver the express package.

In a possible design, the transit address is an address that is in the first logistics path and that is adjacent to the shipper address.

In a possible design, the terminal receives a logistics status of the express package that is pushed by the logistics server.

According to the solution provided in this embodiment of this application, the terminal may further display the logistics status of the express package to the user such that the user visually tracks and learns of a delivery status of the express package, thereby improving user experience.

According to a third aspect, this application provides a logistics server, and the logistics server includes a receiving unit configured to receive order information sent by a terminal, where the order information includes a shipper address, a consignee address, and configuration address information, and the configuration address information includes a transit address and/or a non-transit address specified by a user of the terminal, and a path planning unit configured to plan a first logistics path based on the shipper address, the configuration address information, and the consignee address, where the first logistics path includes the transit address, or the first logistics path does not include the non-transit address, or the first logistics path includes the transit address and does not include the non-transit address.

In a possible design, the path planning unit is further configured to calculate a first additional express fee, and push the first additional express fee to the terminal, where the first additional express fee is a difference between an express fee used for delivery performed through the first logistics path and an express fee used for delivery performed through a predetermined logistics path, and/or the path planning unit is further configured to calculate a first additional time, and push the first additional time to the terminal, where the first additional time is a difference between delivery duration used for delivery performed through the first logistics path and delivery duration used for delivery performed through the predetermined logistics path.

In a possible design, the path planning unit is further configured to calculate a first express fee used for delivery performed through the first logistics path, and push the first express fee to the terminal, and/or the path planning unit is further configured to calculate a first estimated arrival time for delivery performed through the first logistics path, and push the first estimated arrival time to the terminal.

In a possible design, a path updating unit is configured to mark the first logistics path, accumulate a quantity of times that the first logistics path is marked, and update a path planning map library with the first logistics path when the quantity of marking times is greater than a preset threshold of a quantity of times, where the path planning map library includes a plurality of paths.

In a possible design, the transit address is an address that is in the first logistics path and that is adjacent to the shipper address.

According to a fourth aspect, this application provides a terminal, and the terminal includes an obtaining unit configured to obtain order information, where the order information includes a shipper address, a consignee address, and configuration address information, and the configuration address information includes a transit address and/or a non-transit address specified by a user of the terminal, and a sending unit configured to send the order information to a logistics server.

In a possible design, the obtaining unit is configured to receive a first additional express fee pushed by the logistics server, where the first additional express fee is a difference between an express fee used for delivery performed through a first logistics path and an express fee used for delivery performed through a predetermined logistics path, and/or the obtaining unit is further configured to receive a first additional time pushed by the logistics server, where the first additional time is a difference between delivery duration used for delivery performed through the first logistics path and delivery duration used for delivery performed through the predetermined logistics path.

In a possible design, the obtaining unit is further configured to receive a first express fee pushed by the logistics server, where the first express fee is an express fee calculated by the logistics server for delivery performed through the first logistics path, and/or the obtaining unit is further configured to receive a first estimated arrival time pushed by the logistics server, where the first estimated arrival time is an arrival time calculated by the logistics server for delivery performed through the first logistics path.

In a possible design, the transit address is an address that is in the first logistics path and that is adjacent to the shipper address.

According to a fifth aspect, this embodiment of this application discloses a graphical user interface of a terminal, where the terminal includes a touchscreen, a memory, and one or more processors configured to execute one or more programs stored in the memory, the graphical user interface includes a first page, a first control and a second control are displayed on the first page, the first control is used to receive and display a shipper address and a consignee address that are entered by a user, the second control is used to receive and display configuration address information entered by the user, and the configuration address information includes a user-specified transit address and/or non-transit address, and the configuration address information is displayed in the second control in response to the configuration address information that is entered by the user and that is detected by the second control.

In a possible design, the first page further includes a third control, and the third control is used to display a first additional express fee of an express package, the first additional express fee is displayed in the third control in response to the shipper address and the consignee address of the express package that are entered by the user and that are detected by the first control and the configuration address information that is entered by the user and that is detected by the second control, and the first additional express fee is a difference between an express fee used for delivery performed through a first logistics path and an express fee used for delivery performed through a predetermined logistics path.

In a possible design, the first page further includes a fourth control, and the fourth control is used to display a first additional time, and a first estimated arrival time is displayed in the fourth control in response to the shipper address and the consignee address of the express package that are entered by the user and that are detected by the first control and the configuration address information that is entered by the user and that is detected by the second control, and the first estimated arrival time is an arrival time for delivery performed through the first logistics path.

In a possible design, the first page further includes a fifth control, and the fifth control is used to receive an operation that is entered by the user and that is used to enter a second page of the graphical user interface, the second page is displayed in response to the operation that is entered by the user, that is used to enter the second page, and that is detected by the fifth control, where the second page includes a sixth control that is used to displays information about a second logistics path, the path information of the second logistics path is displayed in response to the operation that is entered by the user, that is used to enter the second page, and that is detected by the fifth control, and the second logistics path includes another path than the first logistics path in a plurality of paths planned based on the shipper address and the consignee address, the path information of the second logistics path includes a second additional express fee and a second estimated arrival time, the second additional express fee is a difference between an express fee used for delivery performed through the second logistics path and an express fee used for delivery performed through the predetermined logistics path, and the second estimated arrival time is an arrival time for delivery performed through the second logistics path.

The predetermined logistics path may be a path (namely, the predetermined logistics path) that is preset (or default) in a path planning map library and that is from the shipper address to the consignee address.

According to the solution provided in this embodiment of this application, the terminal receives the first additional express fee, the first estimated arrival time, the second additional express fee, and the second estimated arrival time of the express package such that the user learns of an express fee and delivery duration used for delivering the express package through the first logistics path and an express fee and delivery duration used for delivering the express package through the second logistics path. In this way, the user decides, based on user's requirements for an express fee and delivery duration, whether to choose the first logistics path or the second logistics path for delivery, and the solution is more user-friendly.

According to a sixth aspect, an embodiment of this application discloses a logistics server, and the logistics server includes a memory, a processor, an input/output system, a communications module, and a power supply device. The memory, the processor, the input/output system, the communications module, and the power supply device are connected with each other using a communications bus.

The memory is configured to store a program instruction.

The processor is configured to invoke the program instruction in the memory, and perform the following operations receiving order information sent by a terminal, where the order information includes a shipper address, a consignee address, and configuration address information, and the configuration address information includes a transit address and/or a non-transit address specified by a user of the terminal, and planning a first logistics path based on the shipper address, the configuration address information, and the consignee address, where the first logistics path includes the transit address, or the first logistics path does not include the non-transit address, or the first logistics path includes the transit address and does not include the non-transit address.

In a possible design, after planning the first logistics path based on the shipper address, the configuration address information, and the consignee address, the processor is further configured to calculate a first additional express fee, and push the first additional express fee to the terminal, where the first additional express fee is a difference between an express fee used for delivery performed through the first logistics path and an express fee used for delivery performed through a predetermined logistics path, and/or calculate a first additional time, and push the first additional time to the terminal, where the first additional time is a difference between delivery duration used for delivery performed through the first logistics path and delivery duration used for delivery performed through the predetermined logistics path.

In a possible design, after planning the first logistics path based on the shipper address, the configuration address information, and the consignee address, the processor is further configured to calculate a first express fee used for delivery performed through the first logistics path, and push the first express fee to the terminal, and/or calculate a first estimated arrival time for delivery performed through the first logistics path, and push the first estimated arrival time to the terminal.

In a possible design, after planning the first logistics path based on the shipper address, the configuration address information, and the consignee address, the processor is further configured to mark the first logistics path, accumulate a quantity of times that the first logistics path is marked, and update a path planning map library with the first logistics path when the quantity of marking times is greater than a preset threshold of a quantity of times, where the path planning map library includes a plurality of paths.

In a possible design, the transit address is an address that is in the first logistics path and that is adjacent to the shipper address.

According to a seventh aspect, an embodiment of this application discloses a terminal, and the terminal includes a memory, a processor, an input/output system, a communications module, and a power supply device. The memory, the processor, the input/output system, the communications module, and the power supply device are connected with each other using a communications bus.

The memory is configured to store a program instruction.

The processor is configured to invoke the program instruction in the memory, and perform the following operations obtaining order information, and sending the order information to a logistics server, where the order information includes a shipper address, a consignee address, and configuration address information, and the configuration address information includes a transit address and/or a non-transit address specified by a user of the terminal.

In a possible design, after sending the order information to the logistics server, the processor is further configured to receive a first additional express fee pushed by the logistics server, where the first additional express fee is a difference between an express fee used for delivery performed through a first logistics path and an express fee used for delivery performed through a predetermined logistics path, and/or receive a first additional time pushed by the logistics server, where the first additional time is a difference between delivery duration used for delivery performed through the first logistics path and delivery duration used for delivery performed through the predetermined logistics path.

In a possible design, after sending the order information to the logistics server, the processor is further configured to receive a first express fee pushed by the logistics server, where the first express fee is an express fee calculated by the logistics server for delivery performed through the first logistics path, and/or receive a first estimated arrival time pushed by the logistics server, where the first estimated arrival time is an arrival time calculated by the logistics server for delivery performed through the first logistics path.

In a possible design, the transit address is an address that is in the first logistics path and that is adjacent to the shipper address.

According to an eighth aspect, an embodiment of this application discloses a logistics path planning system, including a terminal and a server, where the server is the logistics server disclosed in any one of the third aspect or the possible designs of the third aspect of the embodiments of this application, and the terminal is the terminal disclosed in any one of the fourth aspect or the possible designs of the fourth aspect of the embodiments of this application.

According to a ninth aspect, an embodiment of this application discloses a computer readable storage medium, where the computer readable storage medium stores a computer program, and the computer program includes a program instruction. When the program instruction is executed by a processor, the processor performs the logistics path planning method disclosed in any one of the first aspect or the possible designs of the first aspect of the embodiments of this application, or performs the logistics path planning method disclosed in any one of the second aspect or the possible designs of the second aspect of the embodiments of this application.

The embodiments of this application have the following beneficial effects According to the solutions provided in this application, the logistics server can plan a logistics path based on the user-specified transit address and/or non-transit address. Compared with a case in which the logistics server directly plans a logistics path based on a shipper address and a consignee address, in the solutions provided in this application, the user may participate in logistics path planning, and the transit or non-transit address during delivery of the express package is specified based on user's familiarity with a path around the shipper address or a path around the consignee address such that the express package can be delivered as straight as possible, delivery of the express package that is performed through a longer path in the background is avoided, and a delivery distance of the express package is shortened.

### BRIEF DESCRIPTION OF DRAWINGS

FIG. 1 is a schematic diagram of a path planning map library according to an embodiment of this application;

FIG. 2 is a schematic flowchart of a logistics path planning system according to an embodiment of this application;

FIG. 3A is a schematic diagram of a first page of a graphical user interface according to an embodiment of this application;

FIG. 3B is a schematic diagram of a first page of another graphical user interface according to an embodiment of this application;

FIG. 3C is a schematic diagram of a first page of another graphical user interface according to an embodiment of this application;

FIG. 3D is a schematic diagram of a first page of another graphical user interface according to an embodiment of this application;

FIG. 4 is a schematic diagram of another path planning map library according to an embodiment of this application;

FIG. 5 is a schematic diagram of a second page of a graphical user interface according to an embodiment of this application;

FIG. 6A is a schematic structural diagram of a logistics server according to an embodiment of this application;

FIG. 6B is a schematic structural diagram of another logistics server according to an embodiment of this application;

FIG. 7 is a schematic structural diagram of a terminal according to an embodiment of this application;

FIG. 8 is a schematic structural diagram of another terminal according to an embodiment of this application; and

FIG. 9 is a schematic structural diagram of another logistics server according to an embodiment of this application.

### DESCRIPTION OF EMBODIMENTS

The following clearly describes the technical solutions in the embodiments of this application with reference to accompanying drawings in the embodiments of this application.

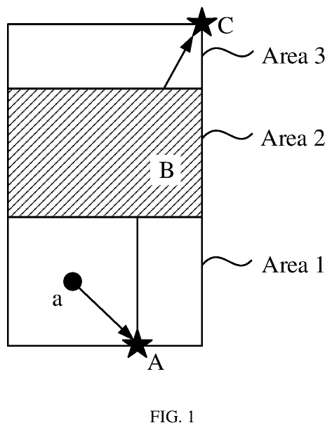

For ease of understanding of the technical solutions provided in the embodiments of this application, the following may first describe a path planning map library applied to the embodiments of this application. A logistics server may pre-divide an entire logistics area into a plurality of small areas, and set up a distribution center in each small area. If there is a to-be-delivered express package in a small area, the express package may be first delivered to a distribution center in the area, and then uniformly delivered from the distribution center in the local area to a consignee address layer by layer based on areas. A path selection may be performed between distribution centers in small areas based on a shortest path algorithm such as a Dijkstra's algorithm, the shortest path faster algorithm (SPFA) algorithm, or a Floyd's algorithm. After the foregoing steps are performed, a path planning map library of the entire logistics area may be formed. FIG. 1 is a schematic diagram of a path planning map library according to an embodiment of this application. As shown in FIG. 1, an entire logistics area is represented using a large rectangle, and a logistics server may pre-divide the entire logistics area into three areas, an area 1, an area 2, and an area 3, and set up a distribution center A in the area 1, a distribution center B in the area 2, and a distribution center C in the area 3. As shown in FIG. 1, a node a is in the area 1, and if there is an express package that is at the node a and that is to be delivered to the distribution center C, the express package may be first delivered to the distribution center A in the area 1, and then the express package is delivered from A to C via the distribution center B such that the path planning map library shown in FIG. 1 is formed. If there is an express package that is at the node a and that is to be delivered to the distribution center C in the path planning map library, a logistics path of the express package is aABC.

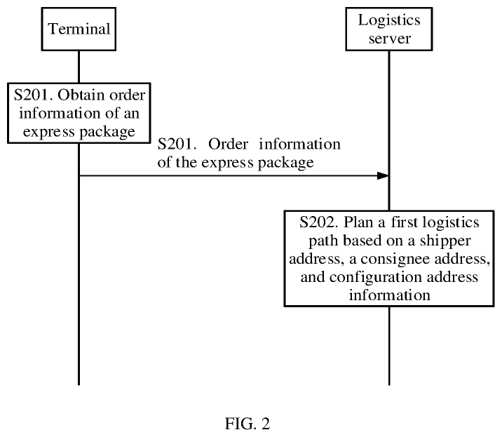

FIG. 2 is a schematic flowchart of a logistics path planning system according to an embodiment of this application. As shown in FIG. 2, the logistics path planning system may include the following steps.

Step S201. A terminal obtains order information, and sends the order information to a logistics server.

The terminal may obtain the order information by scanning, using a connected bar code scanner, a bar code that carries the order information, or the terminal may obtain the order information using a graphical user interface. The graphical user interface may include an e-commerce website, a graphical user interface of an e-commerce client, a logistics company website, a graphical user interface of a logistics company client, and the like. In this application, the order information may include a shipper address, a consignee address, and configuration address information, and the configuration address information includes a user-specified transit address and/or non-transit address. Further, the user-specified transit address may be included in a logistics path plan, and may be a user-specified next address of the shipper address, a user-specified previous address of the consignee address, another user-specified transit address between the shipper address and the consignee address, or the like. The terminal may include a device such as a smartphone, a tablet computer, a palmtop computer, a personal digital assistants (PDA), and a mobile Internet device (MID).

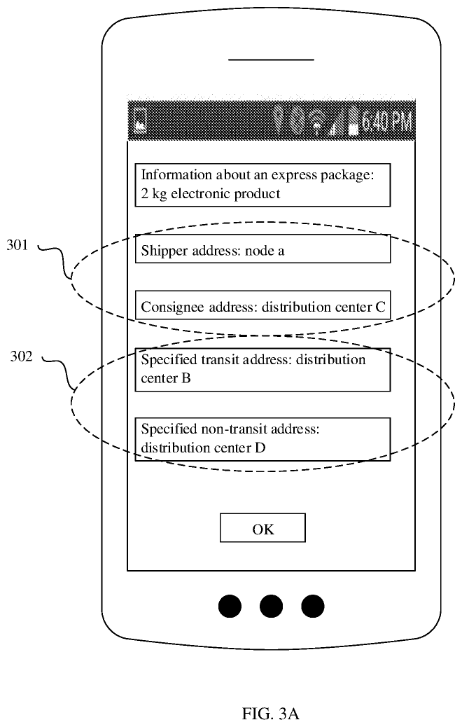

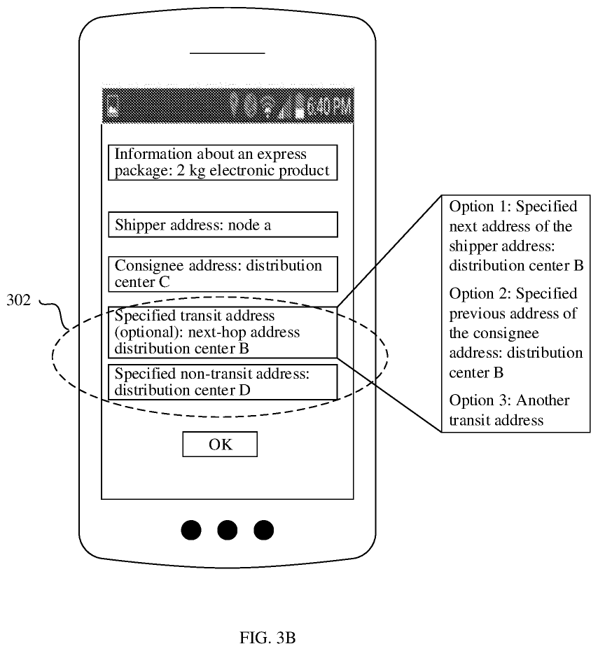

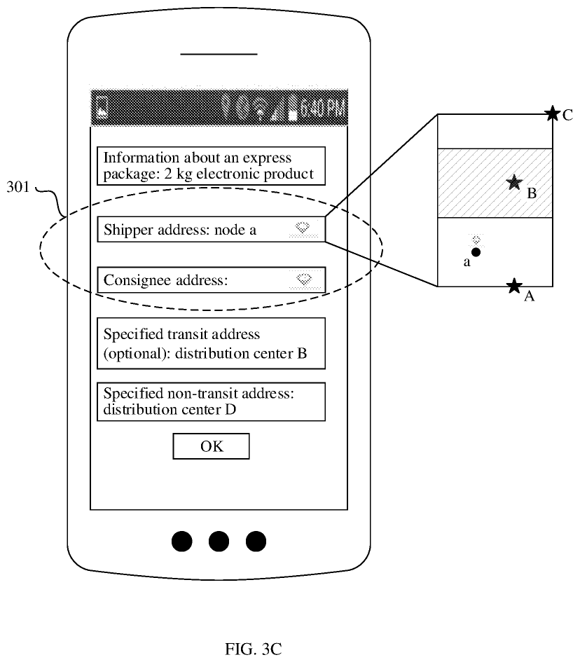

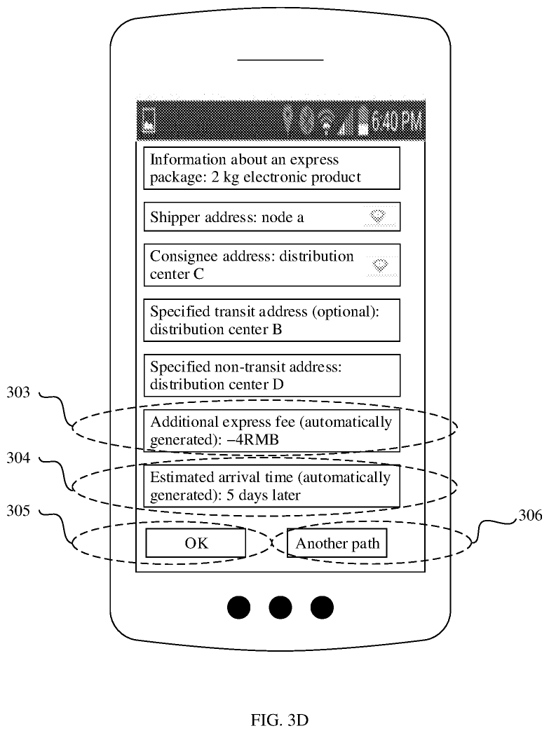

An embodiment of this application provides schematic diagrams of a plurality of graphical user interfaces of a terminal. As shown in FIG. 3A, a first control 301 and a second control 302 are displayed on a first page of a graphical user interface. The first control 301 receives and displays a shipper address and a consignee address that are entered by a user, and the second control 302 receives and displays configuration address information entered by the user. Specific control types may be as follows.

(1). As shown in FIG. 3A, the first control 301 and the second control 302 may be text box controls, and the user may directly fill in corresponding information in the first control 301 and the second control 302, and the first control 301 and the second control 302 receive and display information filled in by the user. For example, the user may separately fill in a node a in a shipper address and fill in a distribution center C in a consignee address in the first control 301, and fill in a distribution center B in a specified transit address in the second control 302. Then, the first control 301 and the second control 302 receive and display the node a filled in by the user in the shipper address, the distribution center C filled in by the user in the consignee address, and the distribution center B filled in by the user in the transit address. For another example, the user may further fill in a distribution center D in a specified non-transit address in the second control 302.

(2). As shown in FIG. 3B, the second control 302 may be a drop-down list control. The user taps the drop-down list control, and then a plurality of options are popped up. The user may select an option from the plurality of options that are popped up. The second control 302 may receive and display information about the option selected by the user. Further, the logistics server may obtain a shipper address and a consignee address that ate entered by the user, and recommend a plurality of options in logistics path planning, such as a next address of the shipper address, a previous address of the consignee address, or another transit address, to the user based on the obtained shipper address and consignee address, and push the plurality of options to the terminal. The terminal may display the plurality of options in a drop-down list. For example, if the logistics server obtains that the shipper address entered by the user is a node a and the consignee address entered by the user is a distribution center C, the logistics server may recommend, based on a fact that the shipper address is the node a and the consignee address is the distribution center C, that a next address of the node a is a distribution center B, that a previous address of the distribution center C is the distribution center B, another transit address, or the like during logistics path planning, and push the next address of the node a, the previous address of the distribution center C, and the other transit address to the terminal. As shown in FIG. 3B, the user taps the second control 302, and the second control 302 pops up a drop-down list that is on the right of the second control 302 and that includes an option 1 in which the specified next address of the shipper address is the distribution center B, an option 2 in which the specified previous address of the consignee address is the distribution center B, and an option 3 of another transit address. If the user taps the option 1, the second control 302 receives information indicating that a specified next-hop address, of the consignee address, that is entered by the user is the distribution center B, and displays the distribution center B.

(3). As shown in FIG. 3C, the first control 301 may be associated with a positioning system of a smartphone, such as a global positioning system (GPS). The GPS of the smartphone may be started provided that the user taps the first control 301, to obtain a current location of the smartphone. The first control 301 may receive and display the current location, and use the current location as the shipper location. Optionally, the first control 301 may be further associated with third-party * * map software. The associated third-party * * map software may be started and popped up, provided that the user taps the first control 301. The user can mark a shipper address and a consignee address on the third-party * * map software that is popped up. The first control 301 may receive and display the marked shipper address and consignee address, use the marked shipper address as a shipper address, and use the marked consignee address as a consignee address. As shown in FIG. 3C, the user taps a control 301 that is in the first control 301 and in which the user enters a shipper address, and the control 301 may pop up a third-party map on the right of the control 301. The user marks a node a in the third-party map that is popped up, and the control 301 may receive and display the node a, and use the node a as the shipper address.

It should be noted that the foregoing first control and second control each may include at least one control, and different controls may be freely combined. This is not limited in this application.

In addition, the graphical user interface may further include a control used to receive and display information about an express package, and the user may fill in the information about the express package in the control such that the control receives and displays the filled information. For example, as shown in FIG. 3A, FIG. 3B, or FIG. 3C, if the user fills in “2 kg electronic product” in the control that is used to receive and display the information about the express package, the control may receive and display “2 kg electronic product”.

The terminal may establish a communication connection to the logistics server in a wireless communication mode such as cellular mobile communication or a wireless local area network (WLAN), or the terminal may establish a communication connection to the logistics server in a wired communication mode such as optical communication or x digital subscriber line (xDSL). When the terminal obtains the order information about a consignee, the terminal may send the order information to the logistics server in a wireless or wired manner through the communication connection established to the logistics server.

Step S202. The logistics server plans a first logistics path based on the shipper address, the configuration address information, and the consignee address.

Optionally, after the logistics server receives the shipper address, the consignee address, and the configuration address information, the logistics server may plan the first logistics path based on the foregoing shortest path algorithm. For example, if the shipper address is a, the consignee address is C, and the transit address specified by the user is B, the logistics server may obtain the first logistics path from a to C via B based on the shortest path algorithm through calculation. For another example, if the shipper address is a, the consignee address is C, the non-transit address specified by the user is B, the logistics server may obtain, based on the shortest path algorithm through calculation, the first logistics path that is from a to C and that bypasses B. Alternatively, after the logistics server receives the shipper address, the consignee address, and the configuration address information, the logistics server may plan the first logistics path based on a planned path in a path planning map library. The path planning map library includes a plurality of paths.

This embodiment of this application is mainly described using an example in which the logistics server plans the first logistics path based on the planned path in the path planning map library.

Further, if the configuration address information is the transit address specified by the user, and the transit address specified by the user is the next address of the shipper address during logistics path planning, the first logistics path that may be planned by the logistics server based on the planned path in the path planning map library may be a path that is directly from the shipper address to the next address and a planned path that is in the path planning map library and that is from the next address to the consignee address. If the configuration address information is the previous address of the consignee address during logistics path planning, the first logistics path planned by the logistics server may include a planned path that is in the path planning map library and that is from the shipper address to the previous address and a path that is directly from the previous address to the consignee address. For example, a schematic diagram of a path planning map library according to an embodiment of this application is shown in FIG. 4, a planned path in the path planning map library is aABC. If the shipper address received by the logistics server is a, the consignee address received by the logistics server is C, and the user-specified next address, of the shipper address a during logistics path planning, that is received by the logistics server is B, the first logistics path planned by the logistics server may include a path directly from a to B and a planned path BC that is in the path planning map library and that is from B to C, as shown by a thick solid line in FIG. 4. To be specific, the first logistics path is aBC.

After planning the first logistics path, the logistics server may further perform the following operations.

(1). The logistics server calculates a first express fee used for delivery performed through the first logistics path, and pushes the first express fee to the terminal.

(2). The logistics server calculates a first additional express fee used for delivery performed through the first logistics path, and pushes the first additional express fee to the terminal. Further, the logistics server may first obtain a path (namely, a predetermined logistics path) that is preset in the path planning map library and through which the express package is delivered from the shipper address to the consignee address, and then use, as the first additional express fee, a difference between an express fee used for delivering the express package through the first logistics path and an express fee used for delivering the express package through the predetermined logistics path.

For example, as shown in FIG. 4, an express package is delivered from a to C, and the logistics server may obtain the predetermined logistics path aABC from the path planning map library. The logistics server may separately calculate, based on pre-stored express fee calculation formulas, express fees used for delivering the express package through paths aA, AB, and BC, and then calculate a sum of the calculated express fees of the paths to obtain an express fee used for delivering the express package through the predetermined logistics path aABC. For example, it is assumed that the pre-stored express fee calculation formulas for the paths aA, AB, and BC are respectively Y=2X, Y=5X, and Y=6X, where X represents a weight of the express package (in kilograms (kg)), and Y represents an express fee (in Chinese Yuan (RMB)). If the express package is 2 kg in weight, and the express fees that are calculated by the logistics server and that are used for delivering the express package through the paths aA, AB, and BC are respectively 4, 10, and 12, the express fee that is calculated by the logistics server and that is used for delivering the express package through the predetermined logistics path is 4+10+12=26. Similarly, the logistics server may separately calculate, based on pre-stored express fee calculation formulas, express fees used for delivering the express package through paths aB and BC, and then calculate a sum of the calculated express fees of the paths, to obtain an express fee used for delivering the express package through the first logistics path aBC. For example, it is assumed that the pre-stored express fee calculation formulas for the paths aB and BC are respectively Y=5X and Y=6X. If the express package is 2 kg in weight, and the express fees that are calculated by the logistics server and that are used for delivering the express package through the paths aB and BC are respectively 10 and 12, the first express fee that is calculated by the logistics server and that is used for delivering the express package through the first logistics path aBC is 10+12=22. Finally, the logistics server may use, as the first additional express fee, a difference 22−26=−4 between the express fee used for delivering the express package through the first logistics path aBC and the express fee used for delivering the express package through the predetermined logistics path aABC (to be specific, the express fee used for delivering the express package through the predetermined logistics path aABC is subtracted from the express fee used for delivering the express package through the first logistics path aBC).

(3). The logistics server calculates a first estimated arrival time for delivery performed through the first logistics path, and pushes the first estimated arrival time to the terminal. Further, the logistics server may pre-collect statistics about duration used for delivering the express package through path segments in the path planning map library, and then use, as the first estimated arrival time, a sum of the duration used for delivering the express package through path segments of the first logistics path.

For example, as shown in FIG. 4, if duration used for delivering the express package through a path segment aB of the first logistics path aBC and duration used for delivering the express package through a path segment BC of the first logistics path aBC are respectively 2 days and 3 days, where the duration is collected by the logistics server, the logistics server may use, as the first estimated arrival time a sum of duration used for delivery performed through paths aB and BC: 2+3=5 days.

(4). The logistics server calculates a first additional time for delivery performed through the first logistics path, and pushes the first additional time to the terminal. Further, the first additional time may be a difference between delivery duration used for delivery performed through the first logistics path and delivery duration used for delivery performed through the predetermined logistics path.

For example, as shown in FIG. 4, the foregoing example is still used, the logistics server obtains that duration used for delivery performed through the first logistics path aBC is 5 days, the logistics server respectively obtains, through statistics collection, that duration used for delivery performed through path segments aA, AB, and BC of the predetermined logistics path aABC is 1 day, 3 days, and 3 days, and uses, as duration used for delivering the express package through the predetermined logistics path, a sum of the duration used for delivery performed through the path segments aA, AB, and BC: 1+3+3=7 days, and the first additional time may be a difference 5−7=−2 days between the delivery duration used for delivery performed through the first logistics path and the delivery duration used for delivery performed through the predetermined logistics path.

The terminal receives and displays calculation results, of the foregoing operations (1) to (4), that are pushed by the logistics server.

An embodiment of this application provides a schematic diagram of another graphical user interface. As shown in FIG. 3D, a first page of a graphical user interface may further include a third control 303 and a fourth control 304. The third control 303 is used to display a first additional express fee, and the fourth control 304 is used to display a first estimated arrival time. Based on the foregoing embodiments, after detecting that the user enters the shipper address, the consignee address, and the specified transit address of the express package in the first control and the second control, the third control 303 and the fourth control 304 may display the first additional express fee and the first estimated arrival time. As shown in FIG. 3D, if the first additional express fee is −4 RMB, the third control 303 may display −4 RMB, and if the first estimated arrival time is “arrival in 5 days later”, the fourth control 304 may display “arrival in 5 days later”.

In this embodiment of this application, the logistics server obtains, through calculation, the first additional express fee, the first additional time, the first express fee, and the first estimated arrival time of the express package, and pushes the first additional express fee, the first additional time, the first express fee, and the first estimated arrival time to the terminal such that the user learns of an express fee and delivery duration used for delivering the express package through the first logistics path. In this way, the user decides, based on user's requirements for an express fee and delivery duration, whether to choose the first logistics path for delivery, and the solution is more user-friendly.

As shown in FIG. 3D, the first page may further include a control 305 used to receive an operation that a user determines a logistics path, for example, when the user taps the control 305, the terminal may send delivery confirmation information to the logistics server such that the logistics server delivers the express package based on the first logistics path. Optionally, when the user taps the control 305, a window indicating that “delivery of the express package succeeds” may be popped up on the first page of the terminal.

In an optional implementation, when the logistics server receives the delivery confirmation information, the logistics server may mark the first logistics path and accumulate a quantity of times that the first logistics path is marked, and when the quantity of times that the first logistics path is marked is greater than a preset threshold of a quantity of times, the logistics server may update the first logistics path to the path planning map library. Further, the logistics server may replace, with the first logistics path, a logistics path that is in the path planning map library and that has the same shipper address and the same consignee address as the first logistics path, to update the first logistics path to the path planning map library. An example is used for description with reference to FIG. 4. The threshold, of the quantity of times, that is preset by the logistics server is 5, as described above, the preset (or default) logistics path from a to C in the path planning map library is aABC, and the first logistics path from a to C is aBC. When the logistics server receives the delivery confirmation information to trigger the logistics server to deliver the express package based on the first logistics path aBC, the logistics server may mark the first logistics path aBC once and accumulate the quantity of times that the first logistics path aBC is marked. When the cumulative quantity of times that the first logistics path aBC is marked is greater than the preset threshold, namely, 5, of the quantity of times, the logistics server may replace the logistics path aABC in the path planning map library with the first logistics path aBC. In other words, when an express package needs to be delivered from a to C next time, the logistics server may directly deliver the express package to C through the path aBC.

Generally, a path that is marked for a relatively large quantity of times may be considered as a hot path with a relative high price/performance ratio. In this embodiment of this application, a path marked for a relatively large quantity of times is used to replace a logistics path that has the same shipper address and the same consignee address as the first logistics path and that is in the path planning map library. In addition to optimizing the path planning map library, a hot path with a relative high price/performance ratio may be provided for the user, thereby improving user experience.

In another optional implementation, the logistics server may further monitor a logistics status when the express package is delivered through the first logistics path. Further, when the express package arrives at an address, a moment and an address at which the express package is currently located may be uploaded to the logistics server, and the logistics server may monitor the logistics status of the express package by receiving information about the moment and the address at which the express package is currently located. For example, if the express package is in the distribution center B at a moment 1 and in the distribution center C at a moment 2, the logistics server may obtain, through monitoring, that the express package is in the distribution center B at the moment 1 and in the distribution center C at the moment 2.

The logistics server may further push, to the terminal, the logistics status of the express package that is obtained through monitoring such that the logistics status of the express package is displayed on the terminal. For example, the logistics status displayed on the terminal may be as follows the distribution center B at the moment 1 to the distribution center C at the moment 2.

According to the solution provided in this embodiment of this application, the logistics server may monitor the logistics status of the express package during delivery at any moment such that when a logistics fault of the express package occurs during the delivery, the logistics fault can be processed in time. In addition, the terminal may further display, to the user, the logistics status obtained through monitoring such that the user visually tracks and learns of a delivery status of the express package, thereby improving user experience.

In an optional implementation, after receiving the shipper address and the consignee address of the express package, the logistics server may further plan a second logistics path that is from the shipper address to the consignee address for user selection. The second logistics path may include another path than the first logistics path in paths from the shipper address to the consignee address. For example, if there are other nodes b1, b2, b3, and the like in FIG. 4, the shipper address of the express package is still a, and the consignee address is still C, the logistics server may plan a second logistics path other than aBC, such as ab1C, ab2C, ab3C, or aBb3C. The logistics server may further calculate a second additional express fee produced when the express package is delivered through the second logistics path, and/or an estimated arrival time for delivering the express package to the consignee address through the second logistics path. For a calculation method of the second additional express fee and a second estimated arrival time, refer to the related descriptions of the first additional express fee and the first estimated arrival time in the foregoing embodiment. Details are not described herein again.

The logistics server may further push the planned second logistics path, the second additional express fee, and the second estimated arrival time to the terminal, and display the planned second logistics path, the second additional express fee, and the second estimated arrival time on the terminal.

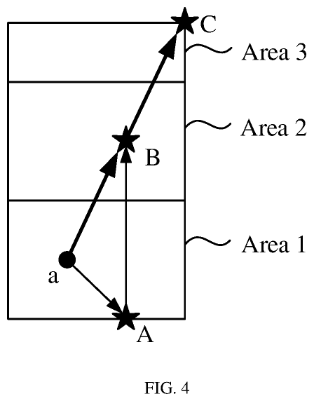

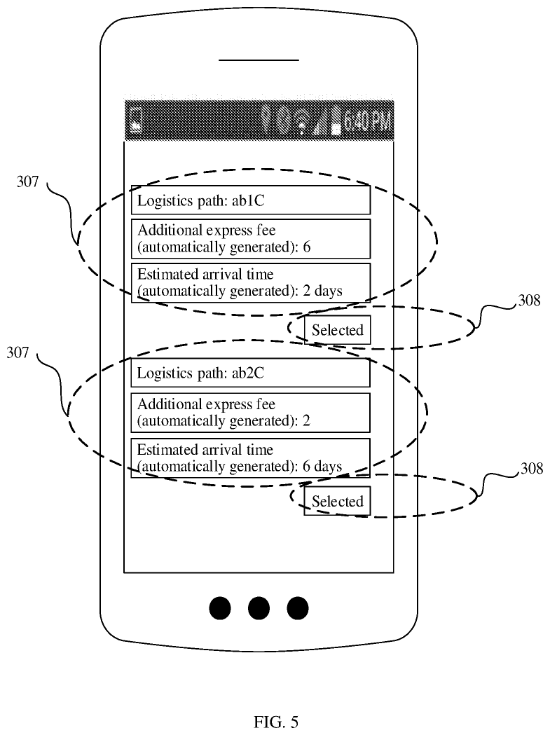

Referring to FIG. 3D, the first page may further include a fifth control 306. The fifth control 306 is used to receive an operation, such as taping or touching the fifth control 306, that is input by a user for entering a second page, and display the second page. Further, the second page may be displayed on the first page in a floating manner and in a form of a window, or the second page is all displayed on the terminal screen as shown in FIG. 5. FIG. 5 is a schematic diagram of a second page of another graphical user interface of a terminal. The second page includes a sixth control 307, and the sixth control 307 is used to display path information such as the second additional express fee and the second estimated arrival time of the second logistics path.

As shown in FIG. 5, the second page includes two sixth controls 307, and the two sixth controls 307 are respectively used to display path information of the second logistics path ab1C and path information of the second logistics path ab2C. To be specific, the upper sixth control 307 may display the second logistics path ab1C, a second additional express fee, namely, 6 RMB, that is produced when the express package is delivered through the second logistics path ab1C, and an estimated arrival time, namely, 2 days, for delivering the express package to the consignee address through the second logistics path ab1C, the lower sixth control 307 may display the second logistics path ab2C, a second additional express fee, namely, 2 RMB, that is produced when the express package is delivered through the second logistics path ab2C, and an estimated arrival time, namely, 6 days, for delivering the express package to the consignee address through the second logistics path ab2C.

In addition, as shown in FIG. 5, the second page may further include a control 308 used to receive an operation that a user determines a logistics path, and the control 308 may respond to an operation of the user, such as taping or touching to determine the logistics path. If the user taps the upper control 308, the control 308 may determine that the logistics path is ab1C. To be specific, the control 308 instructs the logistics server to deliver the express package based on the logistics path ab1C. Similarly, if the user taps the lower control 308, the control 308 may determine that the logistics path is ab2C. To be specific, the control 308 instructs the logistics server to deliver the express package based on the logistics path ab2C.

This embodiment of this application may provide the user with more optional logistics paths such that the user can choose, based on user's requirements for an express fee and delivery duration, a more appropriate path to deliver the express package.

According to the solution provided in this application, the logistics server can plan a logistics path based on the user-specified transit address and/or non-transit address. Compared with a case in which the logistics server directly plans a logistics path based on a shipper address and a consignee address, in the solution provided in this application, the user may participate in logistics path planning, and the transit or non-transit address during delivery of the express package is specified based on user's familiarity with a path around the shipper address or a path around the consignee address such that the express package can be delivered as straight as possible, delivery of the express package that is performed through a longer path in the background is avoided, and a delivery distance of the express package is shortened.

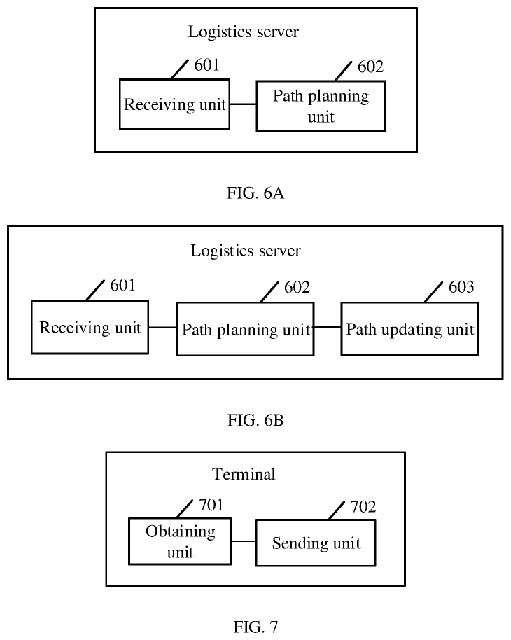

FIG. 6A is a schematic structural diagram of a logistics server according to an embodiment of this application. As shown in FIG. 6A, the logistics server includes a receiving unit 601 configured to receive order information sent by a terminal, where the order information includes a shipper address, a consignee address, and configuration address information, and the configuration address information includes a transit address and/or a non-transit address specified by a user of the terminal, and a path planning unit 602 configured to plan a first logistics path based on the shipper address, the configuration address information, and the consignee address, where the first logistics path includes the transit address, or the first logistics path does not include the non-transit address, or the first logistics path includes the transit address and does not include the non-transit address.

Optionally, the path planning unit 602 is further configured to calculate a first additional express fee of an express package, and push the first additional express fee to the terminal, and/or the path planning unit 602 is further configured to calculate first additional time, and push the first additional time to the terminal. The first additional express fee is a difference between an express fee used for delivery performed through the first logistics path and an express fee used for delivery performed through a predetermined logistics path. The first additional time is a difference between delivery duration used for delivery performed through the first logistics path and delivery duration used for delivery performed through the predetermined logistics path.

Optionally, the path planning unit 602 is further configured to calculate a first express fee used for delivery performed through the first logistics path, and push the first express fee to the terminal, and/or the path planning unit 602 is further configured to calculate a first estimated arrival time for delivery performed through the first logistics path, and push the first estimated arrival time to the terminal.

In an optional implementation, FIG. 6B is a schematic structural diagram of another logistics server. The logistics server may further include a path updating unit 603 configured to mark the first logistics path, accumulate a quantity of times that the first logistics path is marked, and update a path planning map library with the first logistics path when the quantity of marking times is greater than a preset threshold of a quantity of times. The path planning map library includes a plurality of paths.

For descriptions of how to plan the logistics path and descriptions of parameters such as the first additional time, the first additional express fee, the first express fee, and the first estimated arrival time in this embodiment of this application, refer to the related descriptions of the embodiments shown in FIG. 2, FIG. 3A to FIG. 3D. Details are not described herein again.

According to the implementation of this embodiment of this application, a delivery distance of an express package is shortened.

FIG. 7 is a schematic structural diagram of a terminal according to an embodiment of this application. As shown in FIG. 7, the terminal may include an obtaining unit 701 configured to obtain order information, where the order information includes a shipper address, a consignee address, and configuration address information, and the configuration address information includes a transit address and/or a non-transit address specified by a user of the terminal, and a sending unit 702 configured to send the order information to a logistics server.

Optionally, the obtaining unit 701 is further configured to receive a first additional express fee pushed by the logistics server, where the first additional express fee is a difference between an express fee used for delivery performed through a first logistics path and an express fee used for delivery performed through a predetermined logistics path, and/or the obtaining unit 701 is further configured to receive a first additional time pushed by the logistics server, where the first additional time is a difference between delivery duration used for delivery performed through the first logistics path and delivery duration used for delivery performed through the predetermined logistics path.

Optionally, the obtaining unit 701 is further configured to receive a first express fee pushed by the logistics server, where the first express fee is an express fee calculated by the logistics server for delivery performed through the first logistics path, and/or the obtaining unit 701 is further configured to receive a first estimated arrival time pushed by the logistics server, where the first estimated arrival time is an arrival time for delivery performed by the logistics server through the first logistics path.

The transit address is an address that is in the first logistics path and that is adjacent to the shipper address.

For descriptions of parameters such as the first additional time, the first additional express fee, the first express fee, and the first estimated arrival time in this embodiment of this application, refer to the related descriptions of the embodiments shown in FIG. 2, FIG. 3A to FIG. 3D. Details are not described herein again.

According to the implementation of this embodiment of this application, a delivery distance of an express package is shortened.

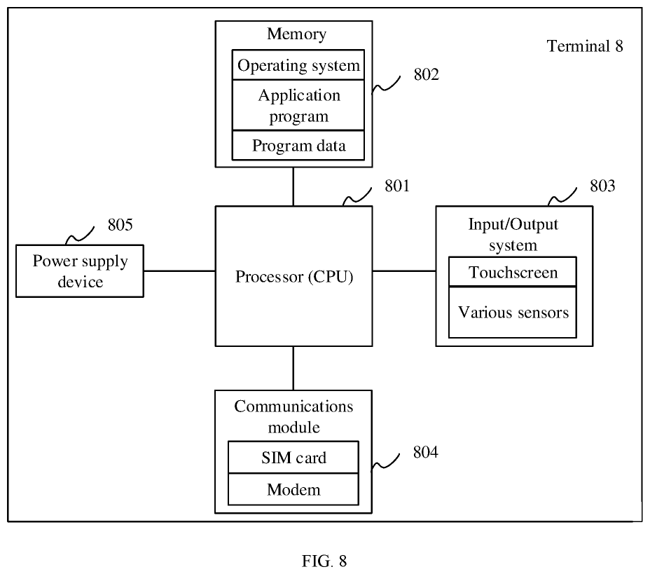

FIG. 8 is a schematic structural diagram of another terminal according to an embodiment of this application. A terminal 8 may include but is not limited to a smartphone, a tablet computer, a PDA, a mobile Internet device, and the like. As shown in FIG. 8, the terminal 8 may include a processor 801, a memory 802 (one or more computer-readable storage media), an input/output system 803, a communications module 804, and a power supply device 805. These components may communicate with each other on one or more communications buses.

The processor 801 may be integrated with one or more central processing units (CPUs) and interpret a computer instruction and process data in computer software.

The memory 802 is coupled to the processor 801 to complete running of an application program, and store various types of application programs and program data, and the like. In specific implementation, the memory 802 may include a random access memory (RAM), an erasable programmable read only memory (ROM) (EPROM), a solid state drive (SSD), a secure digital memory card (SD card), and the like. The memory 802 may further store an operating system (also referred to as a system), for example, an embedded operating system such as an ANDROID, IOS, WINDOWS, or LINUX operating system. The memory 802 may further store a network communications program. The network communications program may be used to communicate with one or more auxiliary devices, one or more terminal devices, and one or more network devices. The memory 802 may further store a user interface program. The user interface program may vividly display content of an application program using a graphical operation interface, and receive, using an input control such as a menu, a dialog box, and a button, a control operation performed by a user on the application program. A software function in the logistics path planning method provided in the embodiments of this application also runs on the memory 802. After an operation of a logistics delivery method ends, the memory 802 may transfer a result of the operation to the processor 801.

The input/output system 803 is mainly configured to control data exchange between various input/output devices, and the input/output devices may include a touchscreen, a camera controller, an audio controller, a GPS, and various sensors such as a gravity sensor, an acceleration sensor, and a distance sensor. It should be noted that the input/output system 20 may further include another input/output peripheral. In specific implementation, the input/output system 803 may input data and information to the processor 801 using input devices such as a camera controller, an audio controller, a GPS, a gravity sensor, an acceleration sensor, and a distance sensor, or the processor 801 may output data using an output device such as a touchscreen or an audio controller.

The communications module 804 is configured to receive and send a radio frequency signal, and mainly integrates a receiver and a transmitter of the terminal 8. The communications module 804 communicates with a communications network and another communications device using the radio frequency signal. In specific implementation, the communications module 804 may include but is not limited to a cellular network, such as a global system for mobile communications (GSM), a universal mobile telecommunications system (UMTS), and long term evolution (LTE) of a universal mobile communications technology, an antenna system, a radio frequency (RF) transceiver, one or more amplifiers, a tuner, one or more oscillators, a digital signal processor, a compression/decompression (CODEC) chip, a subscriber identity module (SIM) card, a storage medium, and the like. In some embodiments, the communications module 804 may be implemented on a separate chip.

The power supply device 805 is mainly configured to provide a highly precise and stable voltage for the processor 801, the input/output system 803, the communications module 804, and the like.

The following describes in detail a collaboration relationship of components in the terminal in this embodiment of this application with reference to specific embodiments.

1. The touchscreen obtains order information. For example, a user may fill in a node a in a shipper address and fill in a distribution center C in a consignee address in the first control 301 shown in FIG. 3A on the touchscreen, and fill in a distribution center B in a specified transit address in the second control 302. Then, the first control 301 and the second control 302 receive and display the node a filled in by the user in the shipper address, the distribution center C filled in by the user in the consignee address, and the distribution center B filled in by the user in the transit address.

2. The touchscreen sends the obtained order information to the processor 801.

3. The processor 801 sends the order information to the communications module 804.

4. The communications module 804 receives the order information and sends the order information to a logistics server.

5. The communications module 804 receives at least one of a first additional express fee, a first additional time, a first express fee, or a first estimated arrival time that is pushed by the logistics server.

For descriptions of parameters such as the first additional express fee, the first additional time, the first express fee, or the first estimated arrival time, refer to the related descriptions of the embodiments shown in FIG. 2, FIG. 3A to FIG. 3D. Details are not described herein again.

6. The communications module 804 sends, to the processor 801, the at least one of the first additional express fee, the first additional time, the first express fee, or the first estimated arrival time that is received by the communications module 804.

7. The processor 801 receives the at least one of the first additional express fee, the first additional time, the first express fee, or the first estimated arrival time, and sends, to the touchscreen for display to the user, the at least one of the first additional express fee, the first additional time, the first express fee, or the first estimated arrival time that is received by the processor. For example, as shown in FIG. 3D, if the first additional express fee is −4 RMB, the third control 303 may display −4 RMB, and if the first estimated arrival time is “arrival in 5 days later”, the fourth control 304 may display “arrival in 5 days later”.

It should be understood that the terminal 8 is merely an example provided in this embodiment of this application. In addition, the terminal 8 may include more or fewer components than those shown, or two or more components may be combined, or the terminal 8 may have different component configurations.

According to the implementation of this embodiment of this application, a delivery distance of an express package is shortened.

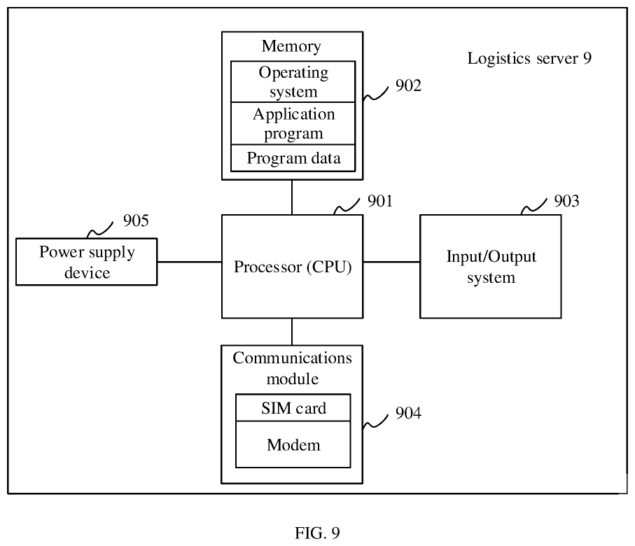

FIG. 9 is a schematic structural diagram of another logistics server according to an embodiment of this application. As shown in FIG. 9, a logistics server 9 may include a processor 901, a memory 902 (one or more computer-readable storage media), an input/output system 903, a communications module 904, and a power supply device 905. These components may communicate with each other on one or more communications buses.

The processor 901 may be integrated with one or more CPUs and interpret a computer instruction and process data in computer software.

The memory 902 is coupled to the processor 901, to complete running of an application program, and store various types of application programs and program data, and the like. In specific implementation, the memory 902 may include a RAM, an EPROM, an SSD, an SD card, and the like. The memory 902 may further store an operating system (a system for short below), for example, an embedded operating system such as an ANDROID, IOS, WINDOWS, or LINUX operating system. The memory 902 may further store a network communications program. The network communications program may be used to communicate with one or more auxiliary devices, one or more terminal devices, and one or more network devices. In this embodiment of this application, the memory 902 stores a path planning map library, where the path planning map library includes a plurality of addresses, and a first logistics path includes a path from a shipper address to a consignee address via a transit address. In addition, a software function of the logistics path planning method provided in the embodiments of this application also runs on the memory 902. After an operation of a logistics delivery method ends, the memory 902 may transfer a result of the operation to the processor 901.

The input/output system 903 is mainly configured to control data exchange between various input/output devices. In specific implementation, the input/output system 903 may input data and information to the processor 901 using an input device, or the processor 901 outputs data using an output device.

The communications module 904 is configured to receive and send a radio frequency signal, and mainly integrates a receiver and a transmitter of the logistics server 9. The communications module 904 communicates with a communications network and another communications device using the radio frequency signal. In specific implementation, the communications module 904 may include but is not limited to a cellular network, such as a GSM, a UMTS, and LTE of a universal mobile communications technology, an antenna system, an RF transceiver, one or more amplifiers, a tuner, one or more oscillators, a digital signal processor, a CODEC chip, a SIM card, a storage medium, and the like. In some embodiments, the communications module 904 may be implemented on a separate chip.

The power supply device 905 is mainly configured to provide a highly precise and stable voltage for the processor 901, the input/output system 903, the communications module 904, and the like.

The following describes in detail a collaboration relationship of components in the logistics server in this embodiment of this application with reference to specific embodiments.

1. The communications module 904 receives order information sent by a terminal, where the order information includes a shipper address, a consignee address, and configuration address information, and the configuration address information includes a transit address and/or a non-transit address specified by a user of the terminal.

2. The communications module 904 sends the received order information to processor 901.

3. The processor 901 invokes program code in the memory 902 to perform calculation based on the order information, to obtain at least one of a first additional express fee, a first additional time, a first express fee, or a first estimated arrival time.

For descriptions of parameters such as the first additional express fee, the first additional time, the first express fee, or the first estimated arrival time, refer to the related descriptions of the embodiments shown in FIG. 2, FIG. 3A to FIG. 3D. Details are not described herein again.

4. The processor 901 sends, to the communications module 904, the at least one of the first additional express fee, the first additional time, the first express fee, or the first estimated arrival time that is obtained through calculation.

5. The communications module 904 sends the at least one of the first additional express fee, the first additional time, the first express fee, or the first estimated arrival time to the terminal.

In another optional implementation, the processor 901 may further mark the first logistics path and accumulate a quantity of times that the first logistics path is marked, and when the quantity of marking times is greater than a preset threshold of a quantity of times, the processor 901 updates the first logistics path to the path planning map library.

According to the implementation of this embodiment of this application, a delivery distance of an express package is shortened.

The logistics path planning method and the device disclosed in the embodiments of this application are described above in detail. The principle and implementations of this application are described herein through specific examples. The description about the embodiments is merely provided to help understand the method and core ideas of this application. In addition, persons of ordinary skill in the art can make modifications to this application in terms of the specific implementations and application scopes based on the ideas of this application. In conclusion, the content of specification shall not be construed as a limit to this application.

1. A logistics path planning method, implemented by a logistics server, comprising:
receiving order information from a terminal, wherein the order information comprises a shipper address, a consignee address, and configuration address information, and wherein the configuration address information comprises a user-specified transit address; and
planning a first logistics path based on the shipper address, the configuration address information, and the consignee address, wherein the first logistics path comprises the transit address.

2. The logistics path planning method of claim 1, wherein the configuration address information further comprises a user-specified non-transit address, and wherein the first logistics path does not comprise the user-specified non-transit address.

3. The logistics path planning method of claim 1, wherein after planning the first logistics path, the logistics path planning method further comprises:
calculating a first additional express fee, wherein the first additional express fee is a difference between a first express fee used for delivery performed through the first logistics path and a second express fee used for delivery performed through a predetermined logistics path; and
pushing the first additional express fee to the terminal.

4. The logistics path planning method of claim 1, wherein after planning the first logistics path, the logistics path planning method further comprises:
calculating a first additional time, wherein the first additional time is a difference between a first delivery duration used for delivery performed through the first logistics path and a second delivery duration used for delivery performed through a predetermined logistics path; and
pushing the first additional time to the terminal.

5. The logistics path planning method of claim 1, wherein after planning the first logistics path, the logistics path planning method further comprises:
calculating a first express fee used for delivery performed through the first logistics path; and
pushing the first express fee to the terminal.

6. The logistics path planning method of claim 1, wherein after planning the first logistics path, the logistics path planning method further comprises:
calculating a first estimated arrival time for delivery performed through the first logistics path; and
pushing the first estimated arrival time to the terminal.

7. The logistics path planning method of claim 1, wherein after planning the first logistics path, the logistics path planning method further comprises:
marking the first logistics path when delivery is performed through the first logistics path;
accumulating a quantity of marking times that the first logistics path is marked; and
updating a path planning map library with the first logistics path when the quantity of marking times is greater than a preset threshold of a quantity of times, wherein the path planning map library comprises a plurality of paths.

8. A logistics path planning method, implemented by a terminal, comprising:
obtaining order information, wherein the order information comprises a shipper address, a consignee address, and configuration address information, and wherein the configuration address information comprises a user-specified transit address; and
sending the order information to a logistics server to enable the logistics server to plan a first logistics path based on the shipper address, the configuration address information, and the consignee address, wherein the first logistics path comprises the transit address.

9. The logistics path planning method of claim 8, wherein the configuration address information further comprises a user-specified non-transit address, and wherein the first logistics path does not comprise the user-specified non-transit address.

10. The logistics path planning method of claim 8, wherein after sending the order information, the logistics path planning method further comprises receiving a first additional express fee from the logistics server, and wherein the first additional express fee is a difference between a first express fee used for delivery performed through the first logistics path and a second express fee used for delivery performed through a predetermined logistics path.

11. The logistics path planning method of claim 8, wherein after sending the order information, the logistics path planning method further comprises receiving a first additional time from the logistics server, and wherein the first additional time is a difference between a first delivery duration used for delivery performed through the first logistics path and a second delivery duration used for delivery performed through a predetermined logistics path.

12. The logistics path planning method of claim 8, wherein after sending the order information, the logistics path planning method further comprises receiving a first express fee from the logistics server, and wherein the first express fee is for delivery performed through the first logistics path.

13. The logistics path planning method of claim 8, wherein after sending the order information, the logistics path planning method further comprises receiving a first estimated arrival time from the logistics server, and wherein the first estimated arrival time is for delivery performed through the first logistics path.

14. A logistics server, comprising:
a receiver configured to receive order information from a terminal, wherein the order information comprises a shipper address, a consignee address, and configuration address information, and wherein the configuration address information comprises a user-specified transit address;
a memory coupled to the receiver and configured to store programming instructions; and
a processor coupled to the memory and the receiver, wherein the programming instructions cause the processor to be configured to plan a first logistics path based on the shipper address, the configuration address information, and the consignee address, and wherein the first logistics path comprises the user-specified transit address.

15. The logistics server of claim 14, wherein the first logistics path further comprises a user-specified non-transit address, and wherein the first logistics path does not comprise the user-specified non-transit address.

16. The logistics server of claim 14, wherein the programming instructions further cause the processor to be configured to calculate a first additional express fee, wherein the first additional express fee is a difference between a first express fee used for delivery performed through the first logistics path and a second express fee used for delivery performed through a predetermined logistics path, and wherein the logistics server further comprises a transmitter coupled to the processor and configured to push the first additional express fee to the terminal.

17. The logistics server of claim 14, wherein the programming instructions further cause the processor to be configured to calculate a first additional time, wherein the first additional time is a difference between a first delivery duration used for delivery performed through the first logistics path and a second delivery duration used for delivery performed through a predetermined logistics path, and wherein the logistics server further comprises a transmitter coupled to the processor and configured to push the first additional time to the terminal.

18. The logistics server of claim 14, wherein the programming instructions further cause the processor to be configured to calculate a first express fee used for delivery performed through the first logistics path, and wherein the logistics server further comprises a transmitter coupled to the processor and configured to push the first express fee to the terminal.

19. The logistics server of claim 14, wherein the programming instructions further cause the processor to be configured to calculate a first estimated arrival time for delivery performed through the first logistics path, and wherein the logistics server further comprises a transmitter coupled to the processor and configured to push the first estimated arrival time to the terminal.

20. The logistics server of claim 14, wherein the programming instructions further cause the processor to be configured to:
mark the first logistics path when delivery is performed through the first logistics path;
accumulate a quantity of marking times that the first logistics path is marked; and
update a path planning map library with the first logistics path when the quantity of marking times is greater than a preset threshold of a quantity of times, wherein the path planning map library comprises a plurality of paths.

21. A terminal, comprising:
a memory configured to store programming instructions;
a processor coupled to the memory, wherein the programming instructions cause the processor to be configured to obtain order information, wherein the order information comprises a shipper address, a consignee address, and configuration address information, and wherein the configuration address information comprises a user-specified transit address; and
a transmitter coupled to the processor and configured to send the order information to a logistics server to enable the logistics server to plan a first logistics path based on the shipper address, the configuration address information, and the consignee address, wherein the first logistics path comprises the user-specified transit address.

22. The terminal of claim 21, wherein the configuration address information further comprises a user-specified non-transit address, and wherein the first logistics path does not comprise the user-specified non-transit address.

23. The terminal of claim 21, further comprising a receiver coupled to the processor and configured to receive a first additional express fee from the logistics server, wherein the first additional express fee is a difference between a first express fee used for delivery performed through the first logistics path and a second express fee used for delivery performed through a predetermined logistics path.

24. The terminal of claim 21, further comprising a receiver coupled to the processor and configured to receive a first additional time from the logistics server, wherein the first additional time is a difference between a first delivery duration used for delivery performed through the first logistics path and a second delivery duration used for delivery performed through a predetermined logistics path.

25. The terminal of claim 21, further comprising a receiver coupled to the processor and configured to receive a first express fee from the logistics server, wherein the first express fee is for delivery performed through the first logistics path.

26. The terminal of claim 21, further comprising a receiver coupled to the processor and configured to receive a first estimated arrival time from the logistics server, wherein the first estimated arrival time is an arrival time obtained from the logistics server for delivery performed through the first logistics path.
